(19) United States
(12) Patent Application Publication
(10) Pub. No.: US 2026/0277034 A1
(43) Pub. Date: Sep. 17, 2026

(54) METHODS AND APPARATUS FOR MODULATING LIGHT

(71) Applicants: Swave BV, Leuven (BE); IMEC VZW, Leuven (BE)

(72) Inventors: Dmitri CHOUTOV; Silviu CRISAN, Huldenberg (BE); Luis Diego HOFFMAN, Leuven (BE); Theodore Michel MARESCAUX, Brussels (BE); Richard STAHL, Rotselaar (BE); Bruno FIGEYS, Leuven (BE); Roelof JANSEN, Leuven (BE); Kristof LODEWIJKS, Leuven (BE); Vladimir PEJOVICH, Leuven (BE); Xavier ROTTENBERG, Leuven (BE); Sandeep Seema SASEENDRAN, Leuven (BE)

(73) Assignees: Swave BV, Leuven (BE); IMEC VZW, Leuven (BE)

(21) Appl. No.: 19/150,980

(22) PCT Filed: Feb. 6, 2024
(86) PCT No.: PCT/US2024/014597

§ 371 Date: Jul. 25, 2025

Related U.S. Application Data
(60) Provisional application No. 63/483,611, filed on Feb. 7, 2023.

(51) Int. Cl. G02F 1/01

(52) U.S. Cl. CPC G02F 1/0147

(57) ABSTRACT

A light modulating array includes a plurality of light modulating elements, where each light modulating element includes a plurality of electrical interconnects and a heater element coupled to the plurality of electrical interconnects and the heater element is configured to receive electrical energy via the plurality of electrical interconnects. Each light modulating element of the device further includes a phase change material implemented proximal to the heater element and an insulator encapsulating the heater element and the phase change material, where the phase change material is configured to exhibit a change in crystal state based on a thermal contribution from the heater element.

### FIELD OF THE DISCLOSURE

The subject disclosure relates to light modulation devices using spatial modulation for optical and non-optical applications.

### BRIEF DESCRIPTION OF THE DRAWINGS

Reference will now be made to the accompanying drawings, which are not necessarily drawn to scale, and wherein:

FIG. 1A provides a cross-sectional view of an example light modulation unit cell array in accordance with various aspects described herein;

FIG. 1B provides an example heater driver matrix for a light modulation unit cell array in accordance with various aspects described herein;

FIG. 2A provides a cross-sectional view of another example light modulation unit cell array in accordance with various aspects described herein;

FIG. 2B provides a cross-sectional view of an example light modulation unit cell in accordance with various aspects described herein;

FIGS. 3A-3F provide a cross-sectional view of example manufacturing steps for a light modulation unit cell in accordance with various aspects described herein;

FIG. 3G illustrates a flow diagram of another example method for manufacturing a light modulation unit cell in accordance with various aspects described herein;

FIGS. 3H-3M provide cross-sectional view of example manufacturing steps for a light modulation unit cell in accordance with various aspects described herein;

FIG. 4A provides a cross-sectional view of an example light modulation unit cell array in accordance with various aspects described herein;

FIG. 4B provides a cross-sectional view of another example light modulation unit cell array in accordance with various aspects described herein;

FIG. 4C provides a cross-sectional view of another example light modulation unit cell array in accordance with various aspects described herein;

FIG. 4D provides a cross-sectional view of another example light modulation unit cell array in accordance with various aspects described herein;

FIG. 4E provides a cross-sectional view of another example light modulation unit cell array in accordance with various aspects described herein;

FIG. 5A illustrates a flow diagram of an example method for manufacturing a light modulation unit cell in accordance with various aspects described herein;

FIG. 5B illustrates a flow diagram of another example method for manufacturing a light modulation unit cell in accordance with various aspects described herein;

FIGS. 6A-6D illustrate example heater element configurations in accordance with various aspects described herein;

FIGS. 7A-7C illustrate example heater element electrode configurations in accordance with various aspects described herein;

FIGS. 8A-8D illustrate example heater element profiles accordance with various aspects described herein;

FIGS. 9A-9C illustrate example heater element and electrode configurations in accordance with various aspects described herein; and

FIG. 10 illustrates an example heater element array in a light modulation unit cell array in accordance with various aspects described herein.

### DETAILED DESCRIPTION

One or more examples are now described with reference to the drawings, wherein like reference numerals are used to refer to like elements throughout. In the following description, for purposes of explanation, numerous details are set forth in order to provide a thorough understanding of the various examples. It is evident, however, that the various examples can be practiced without these details.

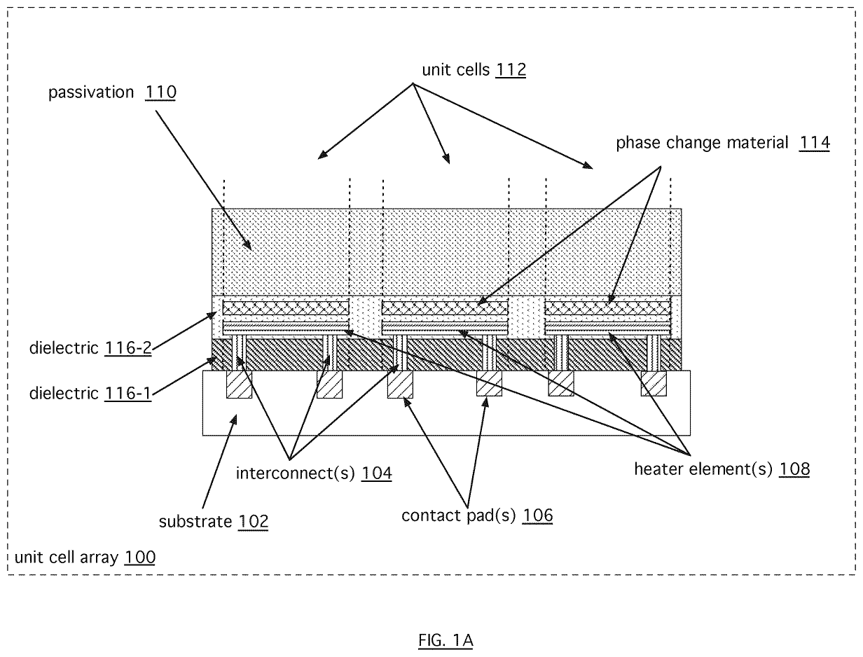

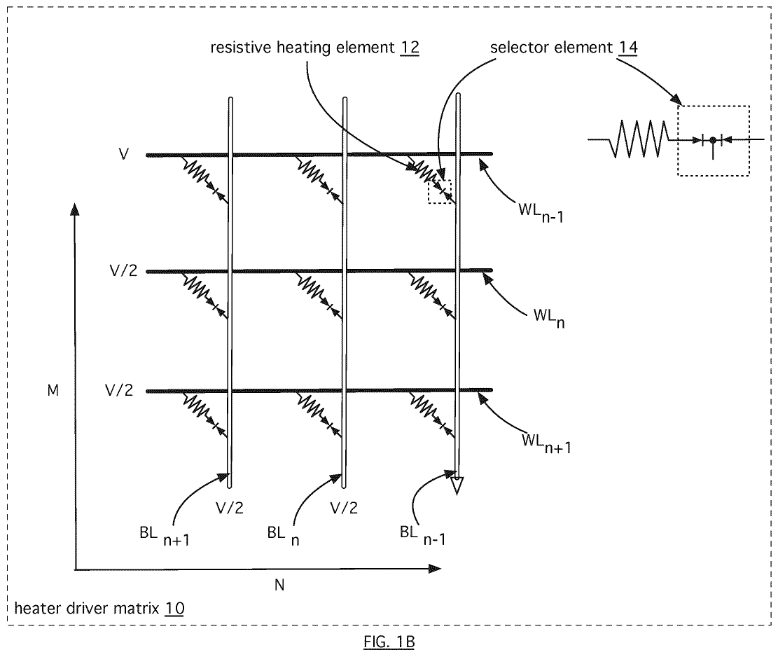

FIG. 1A provides a cross-sectional view of an example light modulation unit cell array 100. In various examples, light modulation can be described as a process for controlling one or more properties of light, such as intensity, phase, polarization, or frequency. In an example, a light modulation process can be a static process. In another example, a light modulation process can be a dynamic process. In further examples of implementation and operation, light modulation can include spatial light modulation, where spatial light modulation can be described as a process for changing the spatial distribution of the amplitude, phase and/or polarization of an optical light field. In another example, spatial light modulation can be described as a process for changing the spatial distribution of the amplitude, phase and/or polarization of an electro-magnetic field. In an example, a spatial light modulator can be a two-dimensional array of pixels that can be used to dynamically modulate light in space and time. In various examples, spatial light modulation can be achieved by altering the phase, amplitude, polarization or any combination thereof of light. In a specific example, an array of tunable pixels can be used to diffract an incoming light beam, enabling the temporal projection of two-dimensional (2D) and three-dimensional (3D) light fields to an observer. In a related example, an incoming light beam spectrum can be selected such that a projected rendering is substantially within the visible spectrum (wavelength range of 400-700 nm) for observation by humans.

In an example, unit cell(s) 112 are formed as stacks on substrate 102, together forming unit cell array 100. As used herein, the term “unit cell” can refer interchangeably to any of a light modulating element, a light modulation element, an independently addressable light modulating element and/or a pixel in a pixel array. Accordingly, a unit cell array can refer to an array of light modulating elements, a light modulation array or a pixel array. In an example of implementation, substrate 102 can be an integrated circuit fabricated through front-end-of-line (FEOL) steps required for the formation of isolated CMOS elements, interconnects, logic structures and control structures. In a more specific example, substrate 102 is fabricated to provide elements configured for electrical connections, such as contact pad(s) 106 for connection to unit cell(s) 112. In an alternative example contact pad(s) 106 can be formed on substrate 102 as one or more process steps used in the formation of unit cell(s) 112. In an example, contact pad(s) 106 are adapted to electrically couple substrate 102 to each unit cell comprising unit cell(s) 112. In yet another example, substrate 102 can include CMOS back-end-of line (BEOL) elements configured to provide electrical interconnections for CMOS elements and electrical connections to unit cell(s) 112.

In an example of implementation and operation, electrical interconnect(s) 104 are formed on substrate 102 to provide electrical connections between various elements of substrate 102 and elements of unit cell 112. In a more specific example, interconnect(s) 104 are formed of one or more electrically conductive materials separated by one or more insulating materials (dielectrics), the one or more insulating materials comprising at least a portion of dielectric 116-1, to provide thermal separation and/or electrical isolation between individual elements of unit cell(s) 112 and to provide electrical isolation between electrical interconnect(s) 104. In various examples, each interconnect of interconnect(s) 104 is adapted to provide an electrical connection at a first end between a contact pad of contact pad(s) 106 and another element of a unit cell of unit cell(s) 112 at a second end. In an example, dielectric 116-1 is configured to provide electrical isolation between some or all of interconnect(s) 104. Example insulating and/or dielectric materials can include, but are not limited to, Silicon Dioxide (SiO₂), Silicon Nitride (Si₃N₄) and Low-K Dielectrics, which include various organic and inorganic low-K materials, such as fluorinated silicon dioxide (SiOF), organosilicate glass (OSG), and porous low-K dielectrics. Other potential dielectric materials include High-K Dielectric materials that can be characterized as providing reduced physical thickness of a given dielectric layer, with examples including hafnium oxide (HfO₂), zirconium oxide (ZrO₂), and aluminum oxide (Al₂O₃). Other example dielectrics include organic polymers such as polyimides, Borophosphosilicate Glass (BPSG) and Spin-On Glass (SOG).

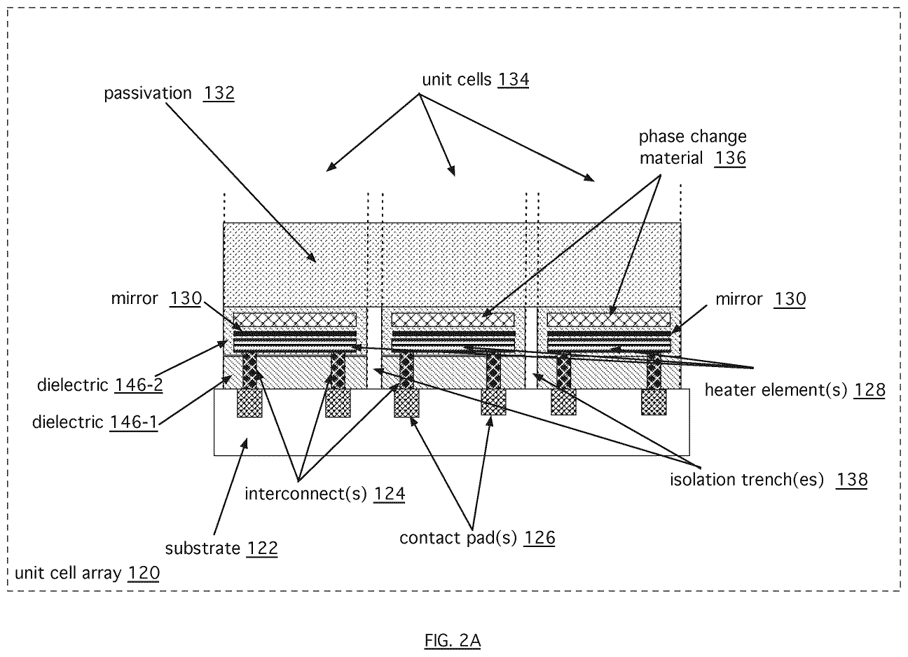

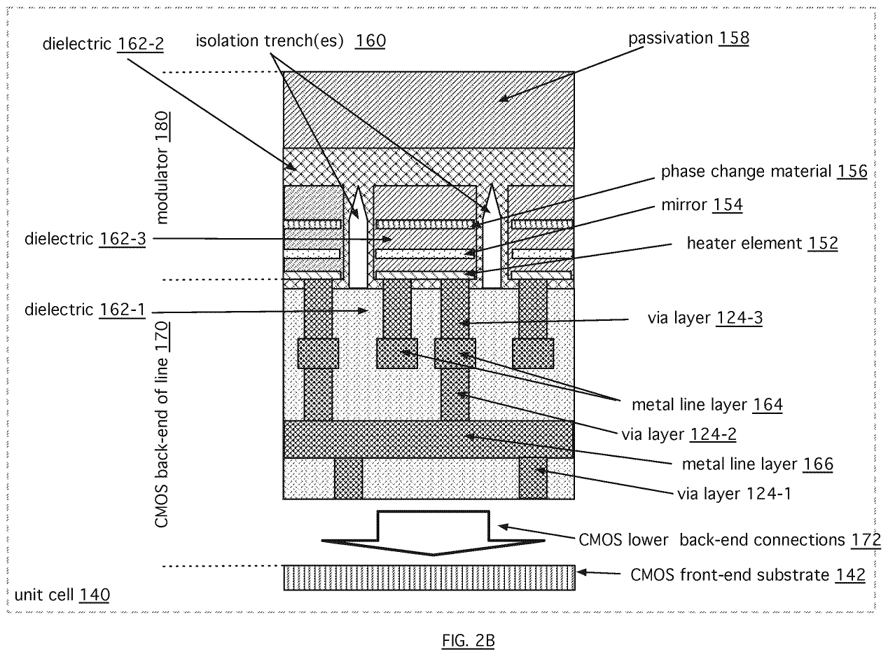

In an example, dielectric 116-1 can be deposited, patterned and etched using various photolithography methodologies to provide voids for the formation of interconnect(s) 104 in the voids. In an example, dielectric 116-1 can be provided with voids for the formation of interconnect(s) 104 by depositing conductive materials over dielectric 116-1, such that the conductive material forms a plurality of conducting structures between substrate 102 and other elements of unit cell(s) 112. Example conductive materials include one or more of aluminum, copper alloy or any other reasonably efficient electrical conductor, but need not comprise a metal material. In a related example, conducting materials can be at least partially removed (using, for example a planarization process and/or a patterning and etching process) to form interconnect(s) 104 to enable coupling to other elements of unit cell(s) 112. In an example of implementation and operation, interconnect(s) 104 can be formed in a plurality of steps, with each interconnect of interconnect(s) 104 comprising additional elements, such as those illustrated in more detail with reference to FIG. 2B. In the various examples, the additional elements can be formed using multiple photolithographic operations to provide routing and connectivity between contact pad(s) 106 and various elements of unit cell(s) 112.

In an example of implementation, substrate 102 can be configured to include processing circuitry for controlling an electric potential and current flow through each interconnect of interconnect(s) 104, such that arrangements of one or more of the interconnects that comprise interconnect(s) 104 can be controlled independently. In an example of implementation and operation, a heater material can be formed over a surface adapted to provide connectivity to at least some of the interconnects of interconnect(s) 104. In the example, heater material can be deposited on the surface over interconnect(s) 104, which can be exposed using one or more etching or planarization processes, enabling coupling for interconnect(s) 104 with the heater material. In a related example, heater material can be patterned to isolate the heater material in each unit cell from adjacent unit cells in order to create heater element(s) 108, where each heater element of heater element(s) 108 is associated with a unit cell of unit cell(s) 112. In an example of operation, unit cell array 100 can be adapted to provide substantially independent application of current to each heater element of heater element(s) 108. In an example of operation, heater element(s) 108 are configured to receive electrical energy via the plurality of interconnect(s) 104 to thereby induce Joule heating in the heater material. Example heater materials include Tantalum Nitride (TaN), electrically conductive metal oxide materials such as Indium Tin Oxide (ITO) or any other material with suitable electrical resistivity. In an example, the stoichiometry of TaN (the ratio of Tantalum atoms to Nitrogen atoms) can be adjusted to achieve a desired electrical resistance for the heater, while optimizing current and voltage applied to the heater element. In a specific related example, an additional factor defining the heater resistance can be TaN film thickness. In an example, by varying TaN stoichiometry and film thickness the resistance of a heater element can be adjusted in a range of 1 Ohm-1000 Ohm.

In an example of implementation and operation, various materials can be formed over the heater material used to form heater element(s) 108 in a completed unit cell stack for unit cell(s) 112, such as the materials described with reference to FIG. 1A and other FIGs described herein. In an example, each unit cell stack includes phase-change material 114 above the heater material comprising heater element(s) 108. In various examples, phase-change material 114 can be a material having a reversible crystal phase property.

In the examples of FIGS. 1A-4E, a phase-change material, such as phase-change material 114, can be adapted to thermally interconvert between one or more crystalline and one or more amorphous states on a relatively short time scale using, for example, a temperature pulse from a heat source. In an example, when changing the phase-change material 114 between relative resistive amorphous and conductive crystalline states, the refractive index of phase-change material 114 is changed, so that amplitude and/or phase of the reflected light can be changed. In an example, once a pulse of temperature concludes the state of phase-change material 114 is “locked-in” and remains unchanged absent a thermal interconversion event. In various examples, phase-change material 114 can be deposited as a thin film atop a dielectric material configured from dielectric 116-2. Deposition techniques for depositing the phase-change material 114 can include, for example, Physical Vapor Deposition (PVD) with the phase-change material being evaporated from a solid source and then condensed onto the substrate. In another example, phase-change material 114 can be deposited using Chemical Vapor Deposition (CVD) with a chemical reaction of gaseous precursors used to form a thin film phase-change material on the surface of dielectric 116-2. Example phase-change materials include but are not limited to GeₓSb_{y}Te_{z} (Germanium Antimony Tellurium), SbₓS_{y} (Antimony Sulfide), SbₓSe_{y} (Antimony Selenide) and MoₓO_{y} (Molybdenum Oxide).

In a related example, dielectric 116-2 can include one or more materials to provide mechanical, electrical or chemical protection for phase-change material 114. In an example of implementation and operation, dielectric 116-2 is configured as anti-diffusion material for phase-change material 114. In an example of implementation, passivation 110 is adapted to provide mechanical and/or electrical protection for unit cell(s) 112. In an additional example, passivation 110 can comprise one or more materials having relatively high thermal insulating properties, including, but not limited to SiO₂ or TiO₂.

In an example of implementation and operation, the phase-change material of a unit cell, such as phase-change material 114, can be adapted to be changeable between two states. In an example, the two states can be a fully crystalline in a first state and fully amorphous in a second state. In an alternative example, the phase-change material of a unit cell can be adapted to be changeable between more than two states: a substantially crystalline state, a substantially amorphous state and somewhere between crystalline and amorphous in one or more additional states. In an explanatory example, a state defined as being between a fully crystalline state and fully amorphous state can indicate formation and growth/expansion of one or more crystalline nucleation sites within an amorphous state. In another explanatory example, a fully crystalline state indicates that one or more crystalline nucleation sites have enlarged sufficiently that no more amorphous state remains. In a specific example, multiple states between a fully crystalline state and a fully amorphous state can be achieved in practice by intentionally stopping the growth of the one or more crystalline nucleation sites at each of multiple growth stages.

FIG. 1B provides an example heater driver matrix 10 for a light modulation unit cell array. In an example of implementation and operation, a matrix G with dimension M×N includes row drivers and column drivers coupled to resistive switching devices, each resistive switching device comprising a resistive heating element 12 and selector element 14. In various examples, heating element 12 can be heater element(s) 108 of FIG. 1A, heater element(s) 128 of FIG. 2A, heater element 152 of FIG. 2B and so forth. Referring to various figures contained herein, each resistive heating element 12 can be heater material patterned into a heater element, where a heater element is associated with a unit cell of a light modulation unit cell array. In an example of operation, a combination of resistive heating element 12 and selector element 14 can be used to provide substantially independent application of electrical energy to a heater element, thereby enabling independent control of thermal energy provided to each unit cell of a unit cell array. In a specific example, selector element 14 can be implemented as a PNP bipolar junction transistor (BJT), so that driving a voltage on wordline n-1 (WLₙ₋₁) row and a voltage on column bit-line n-1 (BLₙ₋₁) biases selector element 14, enabling current to flow through resistive heating element 12. In alternative examples, selector element 14 can be implemented as an NPN bipolar junction transistor but will have an opposite polarity to a PNP bipolar junction transistor. Alternative examples for selector element 14 include but are not limited to any of a field effect transistor, a Darlington pair, an insulated gate bipolar transistor, a silicon-controlled rectifier and an Ovonic Threshold Switching (OTS) selector device. In an example, when selector element 14 is implemented as a PNP bipolar junction transistor selector element 14 can be adapted to switch to an ON state when a negative voltage (relative to the emitter) is applied at the base of the BJT. In an example, when selector element 14 is in an ON state sufficient current can controllably flow through resistive heating element 12 to affect a phase change in a phase-change material associated with resistive heating element 12 and selector element 14. In the example of FIG. 1B, M=3 and N=3, such that the dimension of the matrix is 3×3. In various examples, a light modulation unit cell array can include a large heater driver matrix, enabling large displays and projection devices. In examples relevant to FIGS. 1A-4E, by controlling current flowing through resistive heating element 12, or equivalent, associated phase-change material can be controllably interconverted between conductive crystalline and resistive amorphous phases on a relatively short time scale.

FIG. 2A provides a cross-sectional view of another example light modulation unit cell array. In the example, each unit cell of unit cell array 120 is formed as a stack on substrate 122, together forming unit cell(s) 134. In an example, substrate 122 can be CMOS front-end of line for an integrated circuit fabricated to include elements configured for electrical connections, such as contact pad(s) 126 for connection to heater element(s) 128 of unit cell(s) 134. In an alternative example contact pad(s) 126 can be formed on substrate 122 as one or more process steps used in the formation of unit cell(s) 134.

In an example of implementation and operation, electrical interconnect(s) 124 are formed on substrate 122 to provide electrical connections between various elements of substrate 122 and elements of unit cell 134. In a more specific example, interconnect(s) 124 are formed of one or more electrically conductive materials separated by dielectric 146-1, to provide thermal separation and/or electrical isolation between individual elements of unit cell(s) 134 and to provide electrical isolation between electrical interconnect(s) 124. In various examples, each interconnect of interconnect(s) 124 is adapted to provide an electrical connection at a first end between a contact pad of contact pad(s) 126 and another element of a unit cell of unit cell(s) 134 at a second end.

In an example, dielectric 146-1 can be deposited, patterned and etched using various photolithography methodologies to provide voids for the formation of interconnect(s) 124 in the voids. In an example, interconnect(s) 124 can be formed by depositing conductive materials on dielectric 146-1 that has been configured with voids, such that the conductive material forms a plurality of electrical interconnects between substrate 122 and other elements of unit cell(s) 134. In a related example, conducting materials can be at least partially removed (using, for example a planarization process and/or etching process) to accommodate formation of interconnect(s) 124 for coupling to other elements of unit cell(s) 134.

In an example of implementation and operation, interconnect(s) 124 can be formed in a plurality of steps, with each interconnect of interconnect(s) 124 comprising additional elements. Referring to FIG. 2B, additional elements can be formed using additional photolithographic operations to provide routing and connectivity between contact pad(s) 126 and various elements of unit cell(s) 134.

In an example of implementation and operation, a heater material can be formed over a surface adapted to provide connectivity to at least some of the interconnects of interconnect(s) 124. In the example, the heater material is patterned into separate heater element(s) 128, where each heater element of heater element(s) 128 is associated with a unit cell of unit cell(s) 134. In an example of operation, unit cell array 120 can be adapted to provide substantially independent application of electrical energy to each heater element of heater element(s) 128, thereby enabling independent control of thermal energy provided to each unit cell of unit cell(s) 134.

In an example of implementation and operation, mirror 130 can be formed between heater element(s) 128 and phase-change material 136 of each unit cell of unit cell(s) 134. In an example, mirror 130 can be adapted to function as a reflective element to improve optical performance of unit cell array 120.

In another example of implementation, isolation structures can be formed between adjacent unit cell(s) of unit cell(s) 134 to provide isolation between adjacent unit cell(s). In a related example, the isolation structures can be configured as trenches between individual unit cell(s) of unit cell(s) 134. In various examples, thermal interconversion of phase change material 136 between crystalline and amorphous phases can induce thermal “crosstalk” between an individual unit cell of unit cell(s) 134 that is being interconverted and an adjacent unit cell that is not intended to be interconverted. In another example, isolation between each of adjacent unit cell(s) 134 can enable lower power consumption as a unit cell is selected for interconversion.

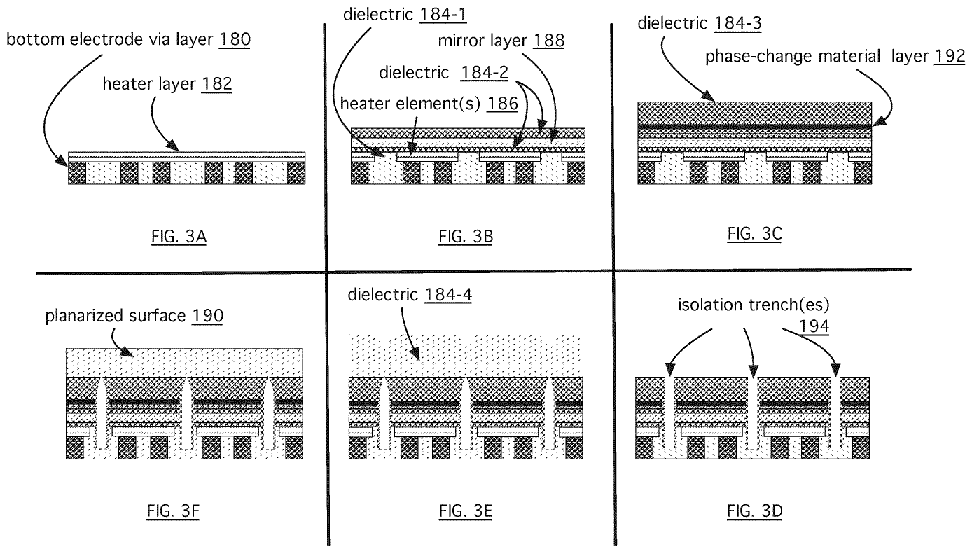

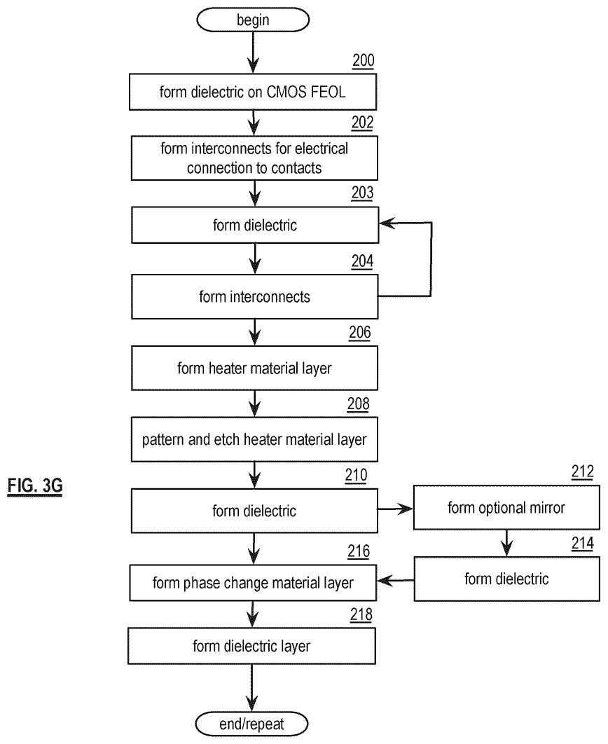

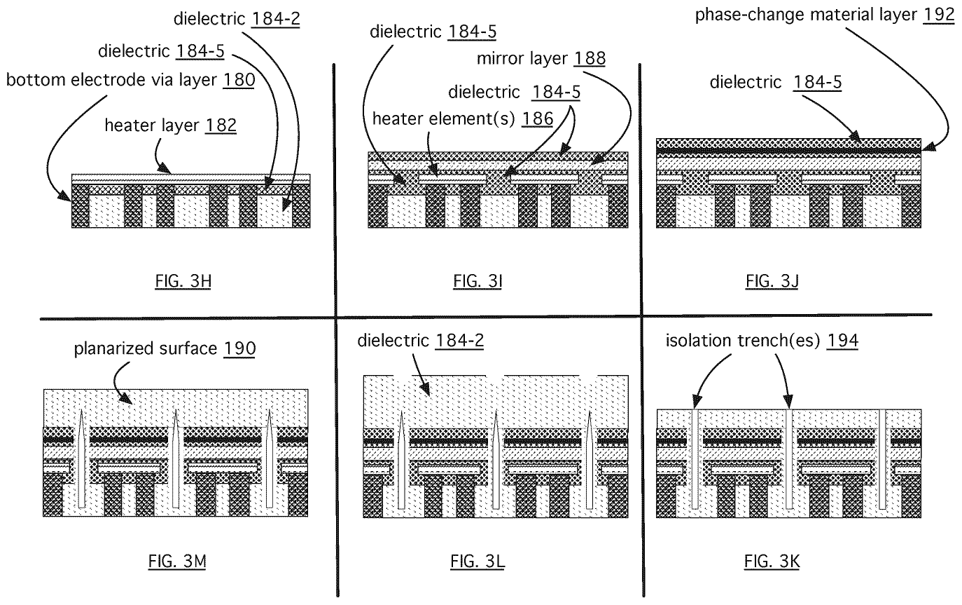

In a specific example of implementation and operation, dielectric 146-2 can be comprised of Si₃N₄, or another material having relatively high thermal conductivity, where thermal conductivity can be described as the rate at which heat is transferred through a material per unit area and per unit temperature gradient. In an example, Si₃N₄ can exhibit higher thermal conductivity relative to the dielectric materials listed above, such as SiO₂ and TiO₂. In an example, dielectric 146-2 can be adapted to encapsulate a heater element of heater element(s) 128 together with the associated phase change material 136, so that heat generated by the heater element is conducted to the associated phase change material 136 in a relatively efficient manner. In a complementary example (described with additional detail in text accompanying FIGS. 3H-3M), dielectric 146-1 can be comprised of SiO₂, where SiO₂, having relatively low thermal conductivity can function to help maintain heat generated by heater element(s) 128 within a capsule provided by dielectric 146-2.

In a related specific example of implementation and operation, dielectric 146-2 can be configured in one or more manufacturing steps to encapsulate selected elements of each light modulating element, such as a heater element of heater element(s) 128, associated mirror 130 and associated phase change material 136 to enable confinement of heat energy and to confine phase-change material 114 while it is in various molten and/or semi-molten states. Such molten and/or semi-molten states can occur during conversion of the crystal state of the phase-change material between an amorphous state and a crystalline state. In a further example, one or more passivation materials, such as passivation 132, can be adapted as a top layer for each of unit cell(s) 112.

In a specific example of implementation and operation, a light modulation unit cell array can include a plurality of light modulation unit cells, where a plurality of isolation structures, such as isolation trench(es) 138 are configured to provide substantial thermal and/or electrical isolation between each unit cell of the array of unit cell(s) 134 from every other unit cell of the array of unit cells. In an alternative example, the isolation structures are configured to provide one or more of thermal isolation, electrical isolation and/or light isolation between each unit cell of the array of unit cell(s) 134 from every other unit cell of the array of unit cells. In a specific example, the isolation trench(es) 138 comprise an air void (sometimes referred to as an air-filled isolation trenches). In another example, isolation trench(es) 138 are configured, as evacuated isolation trench(es) by providing vacuum isolation. In an alternative example, the isolation trench(es) 138 includes a void that is adapted to be backfilled with an insulating material, such as dielectric 146-2, to form filled isolation trenches. In a related example, the trench insulating material is deposited into the trench. In an alternative example, the trench insulating material is a spin-on material applied on a wafer disposed with unit cell(s) 134.

In an example, heater elements, such as the heater element(s) 108 in FIG. 1A, heater elements 128 in FIG. 2A and so forth, can interact with incident light striking the surface of the unit cell(s) 134, such as unit cell(s) 112 in FIG. 1A, unit cell(s) 134 in FIG. 2A and so forth. In an example, incident light can refer to one or more light sources external to the unit cell array and/or one or more light sources integrated with the unit cell array. In an example, incident light can pass around and/or through heater elements (such as heater element(s) 128 in FIG. 2A) onto CMOS elements in an integrated circuit comprising substrate 122, causing resulting in functional errors in those CMOS elements during operation. In a related example of implementation, a metal or other opaque material can be used to block light that would otherwise leak through heater elements (such heater element(s) 128 of FIG. 2A). In a specific example, the metal or other opaque material can be part of the manufacturing process. In an example, light blocking metal layers can be patterned as subwavelength (<½ wavelength) features and configured to function as a meta-surface for blocking specific wavelengths of light that are undesirable for proper function of elements formed in the CMOS front-end-of-line (FEOL). In a related example, one or more light blocking metal layers can be adapted to block RGB wavelengths, by combining features with shapes and sizes tuned for the RGB wavelengths. Alternatively, a different meta-surface layer can be used for each of the respective red, green and blue (RGB) wavelengths. In an example, light blocking structures are adapted as part of the CMOS back-end of line.

FIG. 2B provides a cross-sectional view of an example light modulation unit cell 140. In an example, various CMOS processes can be used to form the components of a CMOS front-end of line (FEOL), such as CMOS front-end substrate 142. Following the formation of FEOL, various example CMOS back-end of line (BEOL) structures can be formed on the CMOS FEOL to enable electrical coupling to components of the CMOS FEOL to one or more unit cells in an array, such as the unit cell 140 of FIG. 2B. In various examples relevant to the embodiments disclosed herein, multilayered CMOS BEOL interconnect structures can be used to couple CMOS front-end substrate 142 elements to heater element(s), such as heater element 152.

In an example of implementation, CMOS BEOL formation can include various process steps, including depositing dielectric layers, depositing metal layers, patterning using photolithography and etching processes, depositing dielectric layers, forming vias and forming interconnects. In an example, the CMOS BEOL can include a plurality of interconnect layers. For example, in the example of FIG. 2B, CMOS lower back-end connections 172 include a plurality of metal interconnect layers formed atop CMOS front-end substrate 142. In an example of implementation, additional CMOS BEOL interconnect layers can include vias, such as via layers 124-1, 124-2 and 124-3, as well as metal line layer 166 and metal line layer 164. In an example, metal line layer 164 and metal line layer 166 can be configured to provide wordline (WL) and bitline (BL) addressing for a given unit cell. In various examples, CMOS lower back-end connections 172 and most additional CMOS BEOL layers can be formed using prevailing CMOS processing and materials.

In an example, the CMOS back-end of line 170 is configured to electrically couple CMOS front-end substrate 142 to heater element 152. Heater element 152 can be electrically isolated from phase change material 156 using dielectric 162-3, with heater element 152 and phase-change material 156 together forming a phase-change modulator 180 of unit cell 140. In the example, isolation trench(es) 160 are formed between unit cell 140 and adjacent unit cells, as discussed with reference to FIG. 2A. In an example, a light reflecting layer (such as a metal layer) can be configured between heater element 152 and phase change material 156 and adapted to function as mirror 154 to improve the optical performance of a unit cell of unit cell(s) 134. In the example illustrated in FIG. 2B, dielectric 162-3 provides electrical isolation between mirror 154 and phase-change material 156. In an alternative example, mirror 154 and phase change material 156 can be configured in direct contact with each other.

In a specific example of implementation and operation, dielectric 162-3 can be comprised of Si₃N₄, or another material having relatively high thermal conductivity, where thermal conductivity can be described as the rate at which heat is transferred through a material per unit area and per unit temperature gradient. In an example, Si₃N₄ can exhibit higher thermal conductivity relative to the dielectric materials with low thermal conductivity, such as SiO₂. In an example, dielectric 162-3 can be adapted to encapsulate the heater material defined as heater element(s) 152 and phase change material 156, so that heat generated by heater element 152 is conducted to phase change material 156 in a relatively efficient manner. In a complementary example, dielectrics 162-1 and 162-2 can be comprised of SiO₂, where SiO₂, having relatively low thermal conductivity, can function to help maintain heat generated by heater element(s) 152 within a capsule provided by dielectric 162-3.

In a related specific example of implementation and operation, dielectric 162-3 can be configured in one or more manufacturing steps to encapsulate selected elements of each light modulating element, such as heater element 152, associated mirror 154 and associated phase change material 156 to enable of each unit cell to aid in confinement of heat energy and to confine phase-change material 156 while it is in various molten and/or semi-molten states.

FIGS. 3A-3F provide cross-sectional view of example manufacturing steps for a light modulation unit cell array. FIG. 3A illustrates the formation of a bottom electrode via layer (BEVA) 180, where the connection vias have been formed in a dielectric and planarized, with the deposition of a heater material to provide heater layer 182. FIG. 3B illustrates the resultant structure after heater layer 182 from FIG. 3A has been patterned, etched, backfilled with dielectric 184-1 and planarized to provide heater element(s) 186. The structure includes deposition of dielectric 184-2 over patterned heater element(s) 186, followed with deposition of mirror layer 188 and then deposition of a 2^{nd} dielectric 184-2 on mirror layer 188. FIG. 3C illustrates the addition of phase-change material layer 192 on the 2^{nd} dielectric 184-2, followed by deposition of dielectric 184-3 over phase-change layer 192. In FIG. 3D, isolation trench(es) 194 are formed to provide electrical and/or thermal isolation of unit cells from adjacent unit cells. Isolation trench(es) 194, can be formed using, for example, various etch processes, including, but not limited to, wet etch processes, reactive ion etch (RIE) processes and deep reactive ion etch (DRIE) processes. FIG. 3E then illustrates the application of dielectric 184-4 over completed unit cells, with FIG. 3F illustrating resultant finished unit cells after one or more planarization steps to provide planarized surface 190. In various examples, additional steps can be added to provide bond pads, etc. for coupling the light modulation unit cell array in a display and/or projection device.

FIG. 3G illustrates a flow diagram of an example method for manufacturing a light modulation unit cell. Note that the flow diagram of FIG. 3G, along with other flow diagrams included herein, are not intended to include each and every processing and/or manufacturing step required to provide a completed light modulation unit cell. Instead, some steps that will be obvious to a person skilled in the art have, therefore, been omitted, in order to provide for more concise disclosure of the various included embodiments. The method begins at step 200 with formation of a dielectric on an integrated circuit already manufactured through CMOS front-end of line (FEOL). At step 202, the method continues by forming interconnects for electrical connection to contact pads provided in the CMOS FEOL. The method continues at step 203, with the formation of another dielectric layer over the interconnects formed at step 202 and then, at step 204, interconnects are formed in the dielectric layer formed at step 203. In an example, steps 203 and 204 can be repeated for multiple layers of interconnects, as needed. At step 206 the method is used to form a heater material layer 206. In an example, the heater material can be deposited to provide electrical coupling to the interconnects formed at step 204. At step 208, the heater material is patterned and etched to isolate the heater material in each unit cell from adjacent unit cells. The method continues at step 210, with a dielectric being deposited over the patterned heater material. In an optional step 212, a mirror layer is deposited over the dielectric deposited at step 210. In an example, the mirror can be a deposited layer adapted to function as mirror to improve optical performance of a light modulation unit cell. When an optional mirror is formed at step 212 the method continues at step 214, by forming an additional dielectric over the mirror formed at step 212. In an example, when optional step 212 is not done the method can be performed without the addition of the dielectric layer at step 214. The method then continues at step 216, by forming a phase change material layer over the dielectric layer formed at step 210, or in the case of the optional mirror layer, over the dielectric layer formed at step 214. Finally, the method then continues by forming a dielectric over the phase change material layer formed at step 218.

FIGS. 3H-3M provide cross-sectional view of another example of manufacturing steps for a light modulation unit cell array. FIG. 3H illustrates the formation of a bottom electrode via layer (BEVA) 180, where the connection vias have been formed in a low thermally conductive dielectric 184-2 and then a high thermally conductive dielectric 184-5 and planarized, with the deposition of a heater material to provide heater layer 182. In the various examples, a high thermally conductive dielectric 184-5 is used to promote the efficient propagation of heat generated at heat element 186 within unit cells of the light modulation unit cell array. FIG. 3I illustrates the resultant structure after the heater layer 182 from FIG. 3H has been patterned, etched, backfilled with dielectric 184-5 and planarized to provide heater element(s) 186, followed with deposition of mirror layer 188 and then deposition of dielectric 184-5 on mirror layer 188. FIG. 3J illustrates a combination of manufacturing steps, including the addition of phase-change material layer 192 on the high thermally conductive dielectric 184-5, followed by deposition of dielectric 184-5 over phase-change material layer 192. In the example, dielectric 184-2 is formed from a low thermally conductive dielectric material, enabling dielectric 184-2 to promote confinement of heat within each unit cell of the light modulation unit cell array.

FIG. 3K illustrates formation of isolation trench(es) 194, where the internal walls of the isolation trenches are implemented with low thermally conductive material, such a dielectric 184-2. The isolation trenches provide electrical and/or thermal isolation of unit cells from adjacent unit cells. In the example, a first trench is formed between unit cells to extend through dielectric 184-5, phase change material 192, dielectric 184-5, mirror layer 188, dielectric electric 184-5 and into dielectric 184-2. The first trench is then backfilled with dielectric 184-2, followed by formation of isolation trench(es) 194. In an alternative example of implementation and operation, low thermally conductive material can be deposited on the internal side walls of isolation trenches to form isolation trench(es) 194. In the example, dielectric 184-2 provides substantial confinement of the heater element 186 and phase-change material layer 192 within a high thermally conductive dielectric capsule, enabling dielectric 184-2 to promote confinement of heat within each unit cell of the light modulation unit cell array, while allowing efficient transfer of heat from heater element 186 to phase-change material layer 192. Isolation trench(es), including isolation trench(es) 194 (including backfilled isolation trench(es) 194), can be formed using, for example, various etch processes, including, but not limited to, wet etch processes, reactive ion etch (RIE) processes, ion drilling and deep reactive ion etch (DRIE) processes. FIG. 3F illustrates resultant finished unit cells after one or more planarization steps to provide planarized surface 190. In various examples, additional steps can be added to provide bond pads, etc. for coupling the light modulation unit cell array in a device such as a display and/or projection device.

The layer sequence of the stack forming a unit cell in the examples illustrated in FIGS. 1A-3K enables a manufacturing method with a relatively easy electrical coupling between a heater element and electrical interconnects. Referring to examples shown in FIGS. 2A and 2B, a mirror can be provided between a heater element and phase-change material in a unit cell stack, with the heat path between the heater element and the phase-change material passing through the mirror. In an example of implementation, a mirror in the configuration of FIGS. 2A and 2B is configured to comprise a melting temperature that is higher than the temperature at which the crystal structure of the phase-change material can be modified.

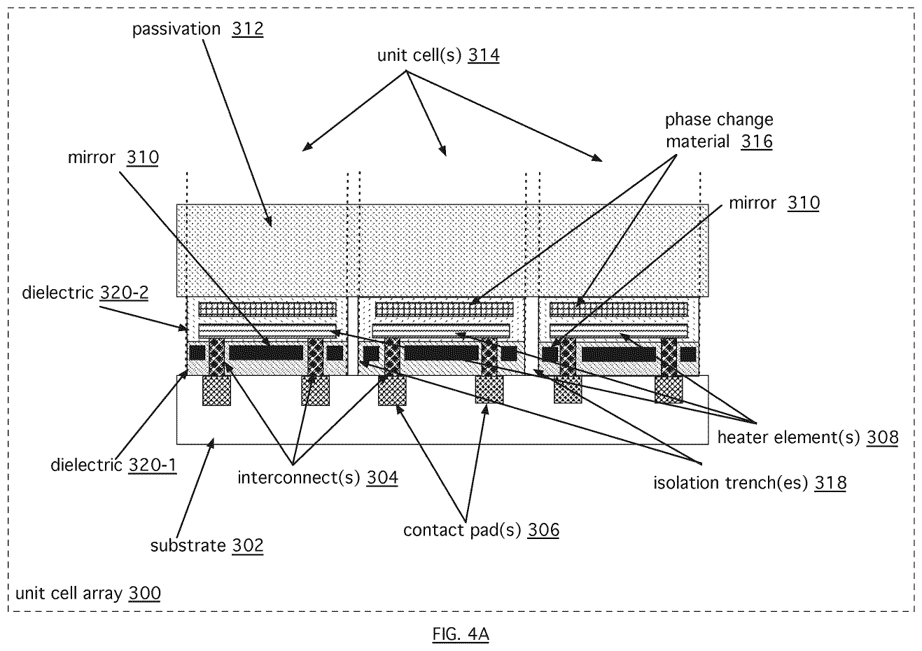

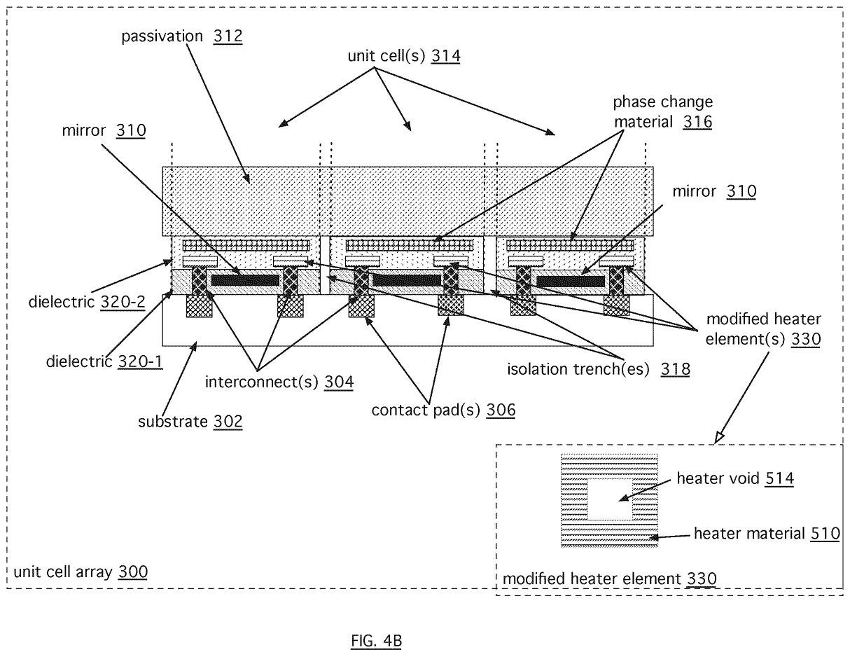

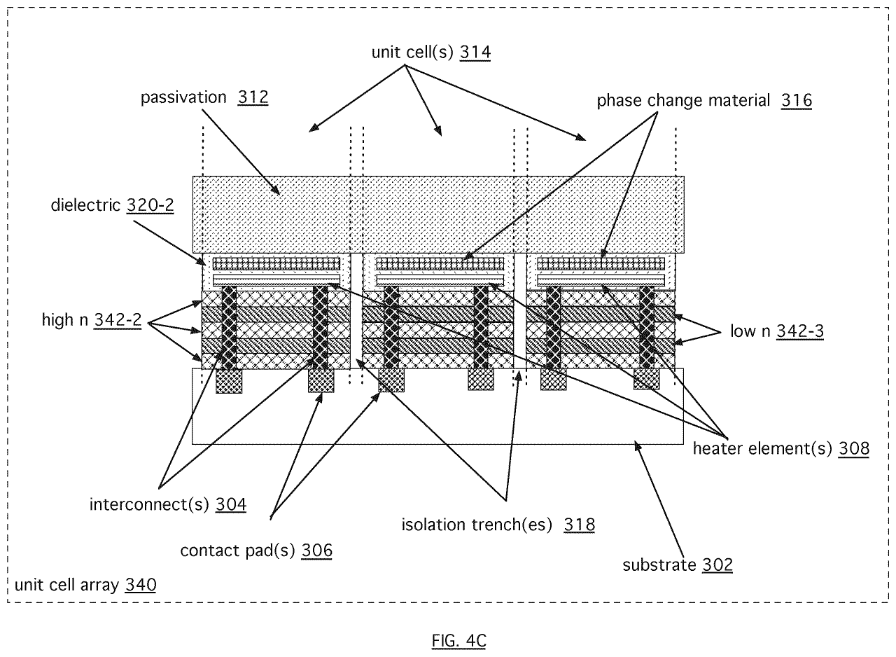

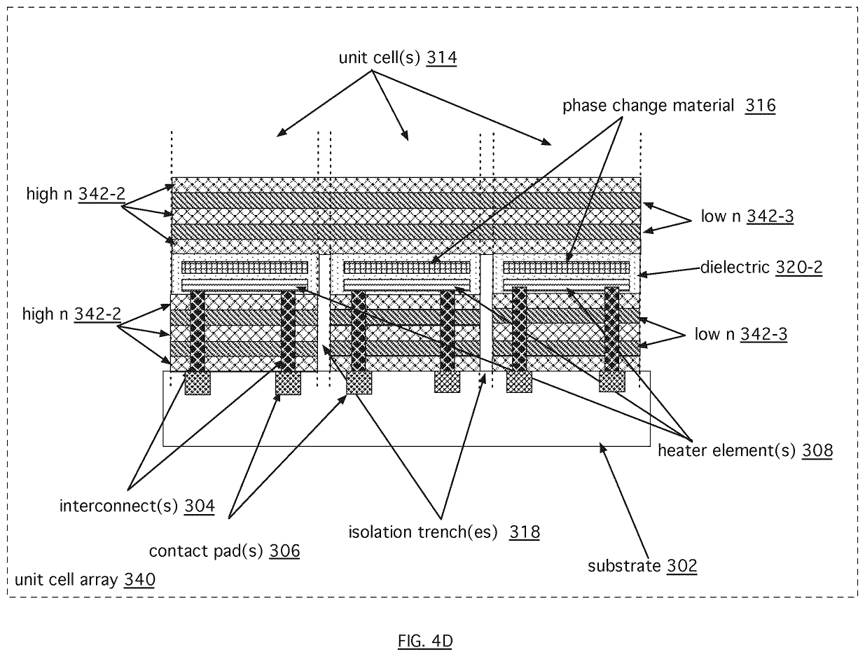

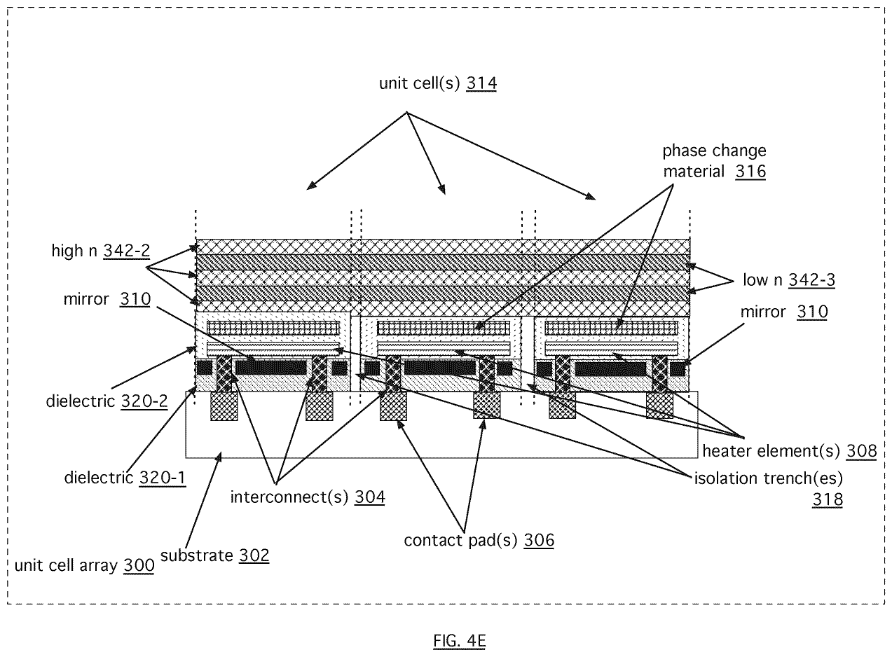

FIG. 4A provides a cross-sectional view of another example light modulation unit cell array 300. In the example, mirror 310 is provided below heater element(s) 308, rather than above heater element(s) 308. In an example, each unit cell of unit cell array 300 is formed as a stack on substrate 302, together forming unit cell(s) 314. In an example, substrate 302 can comprise CMOS front-end of line for an integrated circuit fabricated to include elements configured for electrical connections, such as contact pad(s) 306 for connection to heater element(s) 308 of unit cell(s) 314. In an example, substrate 302 is fabricated to provide elements configured for electrical connections, such as contact pad(s) 306 for connection to heater element(s) 308 of unit cell(s) 314. In an alternative example, contact pad(s) 306 can be formed on substrate 302 as one or more process steps used in the formation of unit cell(s) 314.

In an example of implementation and operation, electrical interconnect(s) 304 are formed on substrate 302 to provide electrical connections between various elements of substrate 302 and elements of unit cell 314. In a more specific example, interconnect(s) 304 are formed of one or more electrically conductive materials separated by one or more insulating materials, the one or more insulating materials comprising at least a portion of dielectric 320-1, which is configured to provide thermal separation and/or electrical isolation between individual elements of unit cell(s) 314 and to provide electrical isolation between electrical interconnect(s) 304. In various examples, each interconnect of interconnect(s) 304 can be adapted to provide an electrical connection at a first end between a contact pad of contact pad(s) 306 and another element of a unit cell of unit cell(s) 314 at a second end.

In an example, dielectric 320-1 can be deposited, patterned and etched using various photolithography methodologies to provide voids for the formation of interconnect(s) 304 and/or mirror 310. In an alternative example, a dielectric material, such as dielectric 320-1, can provide a planarized surface on which a reflective layer can be deposited, followed by a patterning and etching process for the formation of individual mirrors such as mirror 310. In the example of FIG. 4A, holes are etched in mirror 310 for the formation of insulated interconnect(s) 304 to be coupled to heater element(s) 308. In an example, dielectric 320-1 can be added above mirror 310. In an example, interconnect(s) 304 can be formed by depositing conductive materials on dielectric 320-1, where dielectric 320-1 has been configured with voids, such that the conductive material forms a plurality of electrical interconnects between substrate 302 and other elements of unit cell(s) 314.

In an example of implementation, mirror 310 can be adapted to function as a reflective element to improve the optical performance of unit cell array 300. In another example, mirror 310 can be adapted to substantially block incident light from passing through substrate 302 to mitigate the effects of light passing through unit cell(s) 314 to CMOS elements in an integrated circuit comprising substrate 302, thereby avoiding undesirable errors from those CMOS elements during operation. In a related example of implementation, mirror 310 can be composed of a metal or other opaque material adapted to block light that would otherwise pass through unit cell array 300. In a specific example, the metal or other opaque material can be part of the manufacturing process, wherein the material is specifically patterned to block light passing through to the CMOS surface. In an example, mirror 310 can include one or more reflective light blocking layers can be patterned as subwavelength (<½ wavelength) features and configured to function as a meta-surface for blocking specific wavelengths of light that are undesirable for proper function of elements formed in the CMOS front-end-of-line (FEOL). In a related example, one or more reflective layers of mirror 310 can be adapted to block RGB wavelengths, by combining features with shapes and sizes tuned for the RGB wavelengths. Alternatively, a different mirror 310 composition can be used for each of the respective red, green and blue (RGB) wavelengths.

In an example of implementation and operation, dielectric 320-2 is deposited over interconnect(s) 304 and above mirror 310, followed by formation of interconnect(s) 304 through dielectric 320-2 and application of heater material from which heater element(s) 308 can be formed. In a specific example, the heater material can be metallic or semi-metallic. In a specific example, the heater can be configured to be thin enough that it is transparent or semitransparent to specific wavelengths of light, enabling these specific wavelengths of incident light to pass through the heater element(s) 308 and reach the underlying mirror 310. The mirror 310 can reflect back the incident light and increase diffraction efficiency (i.e., the ratio between the power of the diffracted light and the power of the incoming light) thereby improving diffraction efficiency of the cell. Example heater materials include but are not limited to tantalum nitride (TaN) provided at thicknesses of 20 nm and below. In an alternative example, a metal oxide heater material can be used, wherein the metal oxide is adapted to be transparent or weakly absorbing to specific wavelengths of light. Example metal oxide heater materials include indium tin oxide (ITO). In an example, ITO and other metal oxide can be relatively transparent or relatively weakly absorbing at certain wavelengths.

FIG. 4B provides a cross-sectional view of another example light modulation unit cell array 300. In an example of implementation and operation, dielectric 320-2 is deposited over interconnect(s) 304 and above mirror 310, followed with application of heater material from which heater element(s) 330 can be formed. In the example of FIG. 4B, a void is formed in each of heater element(s) 330, enabling light to reach the underlying mirror 310 and to reflect from mirror 310. In an example, a modified heater element 330 comprises heater material 510, where heater material 510 can be any of the heater materials described above, with heater void 514 formed in modified heater element 330. Through the heater void 514, incident light can pass to mirror 310, with reflected light passing back from mirror 310 towards the top of unit cell 314.

In an example of implementation and operation, the diffraction efficiency of light modulation unit cell(s) 314 can be improved by using metal-oxide electrically conducting materials in the place of traditional conducting materials, such as copper (Cu) and copper-tungsten alloy (CuW). Metal-oxide electrically conducting materials include but are not limited to indium tin oxide (ITO), indium gallium zinc oxide (IGZO) and indium tin zinc oxide (ITZO). In certain examples, metal-oxide conducting materials can be used in the formation of (semi)transparent vias to mitigate optical losses and phase mismatch with mirror 310. In an explanatory example, metal vias can have a highly reflective top surface, that, due to a difference in the position of the top surface of these metal vias compared to the position of mirror 310 can contribute to phase mismatch.

FIG. 4C provides a cross-sectional view of another example light modulation unit cell array. In an example, an alternative mirror configuration, such as a Distributed Bragg Reflector (DBR) is used to replace mirror 310 of FIGS. 4A and 4B. In various examples, a DBR can be used to reflect specific wavelengths of light and transmit others. The DBR structure can be configured as alternating layers of materials with different refractive indices to achieve desired reflective properties for light modulation unit cell array 340. In an example, a mirror is formed by fabricating a stack of layers with an alternating higher refractive index, such as high-n 342-2 and lower refractive index, such as low-n 342-3. In an example, the stack of alternating layers can be fabricated with vias formed directly through the dielectric stack. In various examples, the alternating layers can comprise two different materials having distinct refractive indices, where the refractive index contrast between adjacent layers is critical to the reflective properties of the DBR. In some examples the alternating layers can consist of semiconductors and/or dielectric materials. In an alternative example, the mirror is comprised of one or more materials providing a continuous change in refractive index between bottom surface and top surface of the mirror. In an example, the one or more materials the mirror is comprised of, can be doped in such a manner that a continuous change in refractive index between bottom surface and top surface of the mirror is achieved. It is in contrast with the configuration where the mirror is comprised of alternating material layers of high-n and low-n as that results in a step function of the refractive index when transitioning from high-n to low-n and vice versa. In an example of implementation, the reflective layer functioning as a mirror has a respective top surface and a respective bottom surface, wherein the reflective layer is adapted to have a continuously variable refractive index between the top and bottom surface.

In an example, passivation layer 312 of FIGS. 4A-4C, can comprise a material having a relatively high refractive index, instead of the relatively lower refractive index of typical passivation or capping layers. Accordingly, instead of SiO₂ or equivalent material, a capping layer comprising one or more of SiNₓ (plasma enhanced chemical vapor deposition from SiH4 and NH3) or titanium oxide (TiO₂) layers can be deposited on dielectric 320-2 to increase relative reflectivity at the capping layer and air interface. In an example, relatively higher contrast from a capping layer configured with SiNₓ or TiO₂ (or equivalent) to the air interface can provide higher relative reflectivity than lower refractive index materials used as capping layers. In an example of operation, a capping layer configured with SiNₓ or TiO₂ (or equivalent) can provide a stronger optical cavity relative to SiO₂.

FIG. 4D provides a cross-sectional view of another example light modulation unit cell array. In a specific example of implementation and operation, a Distributed Bragg Reflector (DBR), such as the DBR described in reference to FIG. 4C can be provided as a passivation or capping layer. In an alternative example, a passivation or capping layer, as illustrated in FIGS. 1A, 2A, 2B and 4A-4E, can be implemented with one or more materials providing a continuous change in refractive index between bottom surface and top surface of the passivation or capping layer. In an example, the one or more materials comprising the passivation layer, can be doped so as to provide a continuous change in refractive index between bottom surface and top surface of the passivation layer, instead of alternating material layers of high-n and low-n, thereby avoiding a step function in the refractive index when transitioning from high-n to low-n and vice versa. In an example of implementation, a passivation layer has a respective top surface and a respective bottom surface, where the passivation layer is adapted to have a continuously variable refractive index between the top and bottom surface.

FIG. 4E provides a cross-sectional view of another example light modulation unit cell array. In a specific example of implementation and operation, a Distributed Bragg Reflector (DBR), such as the DBR described in reference to FIG. 4C can be provided as a passivation or capping layer. It should be noted that a stack of alternating high-n and low-n dielectric material layer can also be implemented as passivation or capping layer of the examples referred to in FIGS. 1A, 2A and/or 2B, where mirror is implemented between heater element and phase change material.

In the examples of FIGS. 4A-E, the stack forming each unit cell has a layer sequence wherein a heater element is located between the mirror and the phase-change material. In other words, the mirror is located outside the heat path between the heater element and the phase-change material. In an example of implementation, the mirror can be located at a distance of 100 to 200 nm or more from the heating element. In an example of implementation, a mirror material with a relatively low melting temperature, lower than the temperature at which the crystal structure of the phase-change material can be changed, can be used. In a specific example of implementation, the mirror can comprise a metal or similar material with low melting point, such as aluminum (Al). In an example of implementation, the location of the mirror can be configured to create a maximum electric field of the standing wave at the position of the phase-change material, thereby optimizing the optical cavity and enabling maximum tunability. In an additional specific example, the mirror of FIGS. 4A-E can be disposed in dielectric material having a relatively low thermal conductivity, with the low thermal conductivity dielectric enabling a lower melting point mirror material, by insulating the mirror material from the heater element. In a related example, high thermal conductivity dielectric material can be used to enable relatively efficient heat transfer from a heater element to the associate phase-change material, with a low thermal conductivity dielectric used to encapsulate the heater element and phase-change material from transferring excess heat to a mirror disposed below the heater element, with the potential result of higher relative power efficiency, lowered relative material cost and lowered relative manufacturing cost.

In an example of implementation of FIGS. 4A-E the absence of a mirror between the heater element and the phase-change material reduces the distance between the heater element and the phase-change material. In an example of implementation this distance can be further reduced by selecting a minimal thickness of the dielectric layer between the heating element and the phase-change material, such as in the order of 5 nm. A reduced distance between the heating element and the phase-change material enables an efficient heat transfer and can reduce heat consumption.

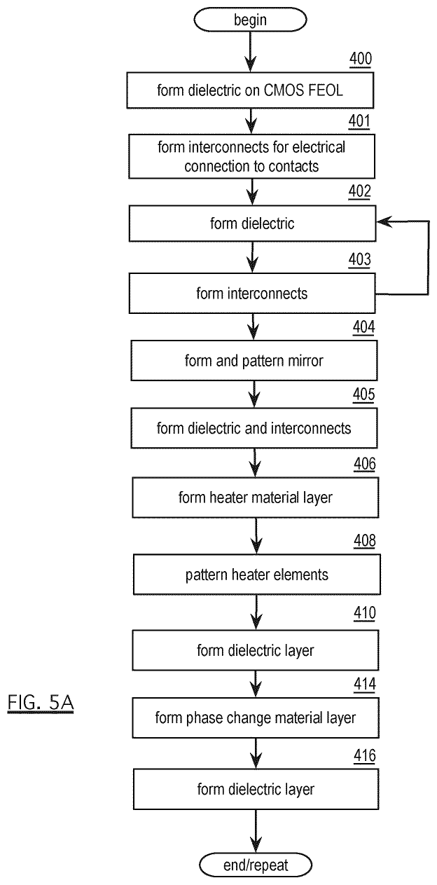

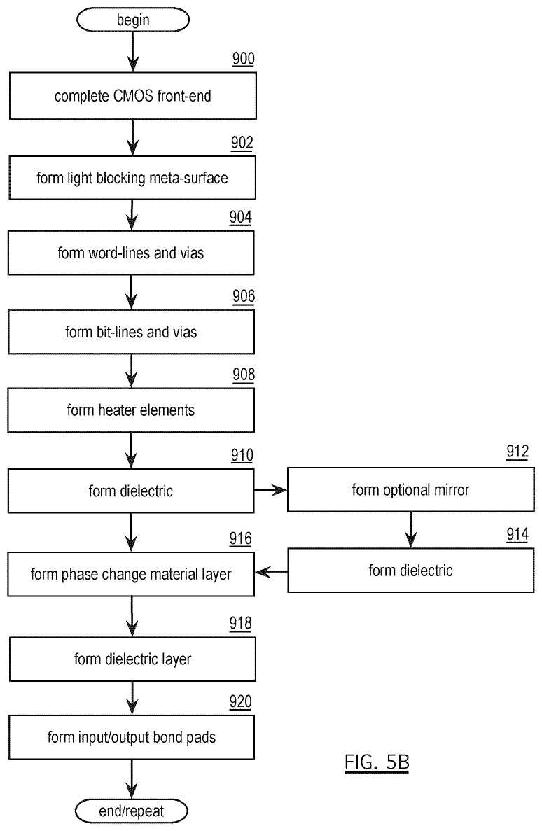

FIG. 5A illustrates a flow diagram of another example method for manufacturing a light modulation array. The method begins at step 400 by forming a dielectric layer on an integrated circuit CMOS front-end of line. At step 401, the method continues by forming interconnects for electrical connection to CMOS FEOL contact pads. The method continues at step 402, with the formation of another dielectric layer over the interconnects formed at step 401 and then, at step 403, interconnects are formed in the dielectric layer formed at step 402. In an example, steps 402 and 403 can be repeated for multiple layers of interconnects, as desired/needed. At step 404, the method continues by forming a mirror layer In an alternative example, step 404 also includes patterning and etching of the mirror layer. The patterning and etching may be used in order to create individual mirrors as well as holes in each mirror for insulated interconnects if required. In a specific example of implementation, a cavity can be formed subsequent to step 403, by patterning and etching the dielectric layer from step 402, followed at step 404 by deposition of the mirror layer in the cavity and a planarization step. In an alternative example, the interconnects and mirror layer can be formed in one or more steps, with interconnect vias and a mirror formed in one or more common manufacturing steps. In yet another example, the mirror layer can be formed in a second deposition, after the interconnects are formed and before planarization. In an alternative operation, step 404 can include multiple process steps to form alternating higher refractive index material and lower refractive index material layers to provide a Distributed Bragg Reflector (DBR) as a mirror layer.

In an example, the mirror layer can be adapted to function as a reflective element to improve optical performance of a unit cell array. In another example, the mirror layer can be adapted to interact with incident light striking the surface of the unit cells in order to mitigate the effects of light passing through unit cells to CMOS elements in an integrated circuit front-end of line (FEOL).

In an example of operation, reducing incident light passing through the unit cells to CMOS elements can mitigate undesirable errors from those CMOS elements during operation. In a related example of implementation, the mirror layer can be composed of copper (Cu) and copper-tungsten alloy (CuW). In an alternative example of implementation the mirror layer can be composed of one or more metal-oxide materials include, but are not limited to indium tin oxide (ITO), indium gallium zinc oxide (IGZO) and indium tin zinc oxide (ITZO). In a specific example, the mirror material can be provided as a step or steps in a manufacturing process, where the mirror material is specifically patterned to cover substantially any corridors for light passing through to the CMOS surface.

The method then continues at step 405, by depositing a dielectric layer over the patterned mirror layer, forming vias in the dielectric layer and forming electrical interconnects in the vias formed at step 403. The method continues at step 406, by forming a heater material layer. In an example, the heater material can be deposited to provide electrical coupling to the interconnects formed at step 405. At step 408, the heater material is patterned and etched to isolate the heater material in each unit cell from adjacent unit cells, forming a separate heater element for each unit cell of the light modulation unit cell array. In an alternative example of implementation, (not shown in FIG. 5A) the heater material is further patterned and etched to provide a void in each heater element. In an example, the heater element void enables incident light to be reflected by the mirror layer described in step 404. The method then continues at step 410, with a dielectric layer deposited over the patterned heater material. The method then continues at step 414, where the dielectric layer deposited at step 410 can be planarized, followed by formation of a phase change material layer. The method then continues at step 416 where a dielectric layer is then formed over the phase change material layer formed to complete step 416.

FIG. 5B illustrates a flow diagram of another example method for manufacturing a light modulation unit cell. The method begins at step 900 by forming a completed CMOS front-end of line integrated circuit. At step 902, the method continues by forming a meta-surface adapted for blocking incident light from the integrated circuit formed at step 900. In an alternative example, step 902 can be skipped, with the method continuing directly to step 904. The method continues at step 904, where word lines and vias are formed in a plurality of steps above and through the meta-surface formed in step 902. The method then continues at step 906, by forming bit-lines and associated vias. In the alternative example where step 902 above has been skipped, the method continues with step 902, after step 906, by forming a meta-surface adapted for blocking incident light from the integrated circuit formed at step 900. At step 908 the method continues by forming heater elements for the light modulation unit cell array. The method then continues at step 910, by forming a dielectric over the heater elements.

In an optional step 912, a mirror layer is formed over the dielectric formed at step 910, followed by formation of another dielectric at step 914. In an example, the mirror layer can be configured as a reflective element to improve optical performance of a unit cell array. In another example, the mirror layer can be adapted to interact with incident light striking the surface of the unit cells in order to mitigate the effects of light leaking through individual unit cells of unit cell array to CMOS elements in an integrated circuit front-end of line (FEOL). In various examples, the mirror layer can be composed of materials such as copper (Cu) and copper-tungsten alloy (CuW) and/or one or more metal-oxide conducting materials including, but not limited to Indium Tin Oxide (ITO), indium gallium zinc oxide (IGZO) and indium tin zinc oxide (ITZO).

The method continues at step 916, where phase change material layer is formed over the dielectric layer formed at step 910, or alternatively, when the optional mirror is included, the phase change material layer is formed over the dielectric layer formed at step 914. The method then continues at step 918 with formation of a dielectric layer to cap the phase change material layer formed at step 916. Finally, the method continues at step 920, with the formation of input/output bond pads in a plurality of steps. to provide a completed light modulation unit cell array.

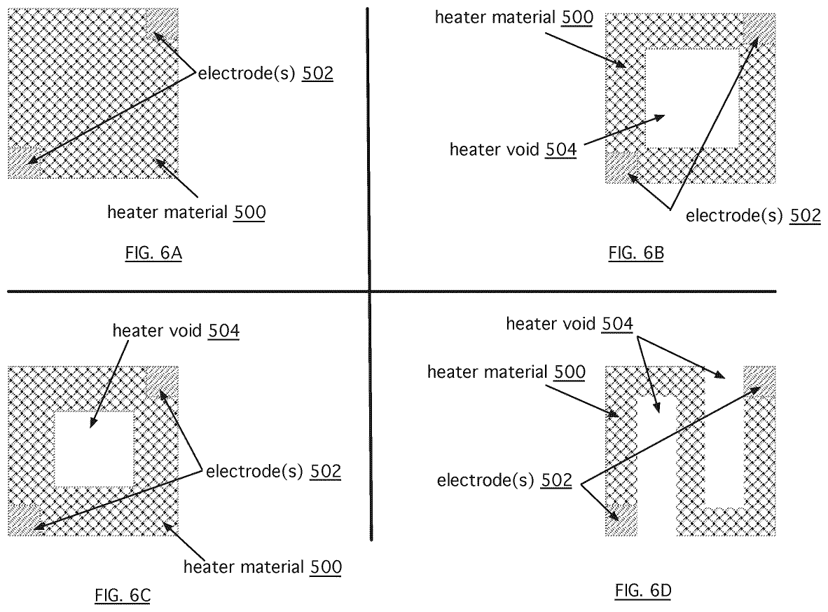

FIGS. 6A-6D illustrate example heater element configurations for a light modulation unit cell. In the various examples, the shape of a heater element, along with the relative locations of electrodes applied to the heater element can be used to influence the heat map pattern generated by the heater element. In the various examples, current flowing through a heater element can distribute heat non-optimally across the heater element. By changing the shape of the heater element, current can be channeled to provide heat in one or more specific/desired areas. In an example of implementation, a heater element can be configured in a two-dimensional geometric shape with straight sides (or edges) having multiple corners or vertices. Accordingly, an example heater element can be configured with a plurality of electrodes, wherein each electrode is located at a different heater element vertex.

In the example of FIG. 6A electrodes 502 are coupled opposite each other at the diagonally opposite corners of a square heater element composed of heater material 500. In an example, current flowing through the resistive heater material 500 will tend to locate a thermal maximum between the diagonally placed electrodes. In the example of FIG. 6A, the electrodes, being located a maximum distance from each other provides a longer resistive path for heater material 500, with presumably higher resistance and therefore a higher relative thermal maximum than electrodes located closer to each other.

In the example of FIG. 6B, electrodes 502 are once again coupled opposite each other to opposite diagonal corners of a square heater element composed of heater material 500, however a heater void 504 located in the center of heater material 500 can influence current flow around the periphery of the heater element. In the example of FIG. 6B, electrodes 502, are located a maximum distance from each other, along with a current flow path around the periphery of a heater material 500 having a square shape, providing an even longer resistive path for heater material 500, as compared to that of FIG. 6A, presumably providing for higher resistance and therefore a higher thermal maximum. Moreover, since the example heater material of FIG. 6B provides for two paths for current flow, the resulting heater element could include two thermal maximums, once at each diagonal without an electrode coupled thereto.

In FIG. 6C, electrodes 502 are again located a maximum distance from each other, along with a current flow path around the periphery of a heater material 500 having a square shape providing a longer relative resistive path for heater material 500, as compared to that of FIG. 6A, however, heater void 504 is smaller, relative to the heater void 504 for FIG. 6B. The example heater material of FIG. 6C provides for two paths for current flow and two thermal maximums, one at each of the diagonally opposite corners between electrodes, providing a larger relative heat map, since current can flow in a wider area. In the example of FIG. 6D, electrodes are once again located at diagonals, however a single current path in an “S” shape provides the longest resistive path of any of FIGS. 6A-6D , presumably providing for higher overall resistance and therefore a higher thermal maximum, located at the linear center point between the two electrodes.

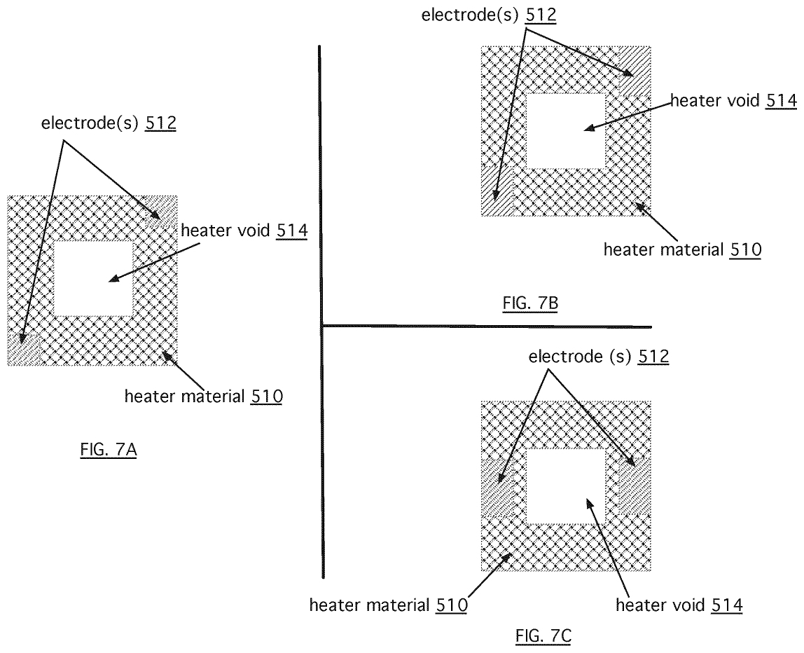

FIGS. 7A-7C illustrate example heater element electrode configurations. In the example of FIG. 7A, electrodes 512 are coupled to heater material 510 opposite each other at diagonally opposite corners of a square heater element, with square/symmetrical electrodes at the coupling location. In the example of FIG. 7B, electrodes 512, are rectangular in shape and larger on one axis, providing a larger overall coupling area on heater material 510. With the larger coupling area, a given current can provide different heat map pattern than that of FIG. 7A, with lower coupling resistance and a wider area for current to flow from, relative to the heater element of FIG. 7A. In the example of FIG. 7C, electrodes 512 are again rectangular, however the electrodes 512 are located opposite each other and centered on sides of a square shaped heater element. In an example, current flowing through heater material 510 would have substantially the same area for current flow as that illustrated in FIG. 7A, however, a larger electrode coupling area can provide for lower resistance and/or lower capacitance at the electrode coupling.

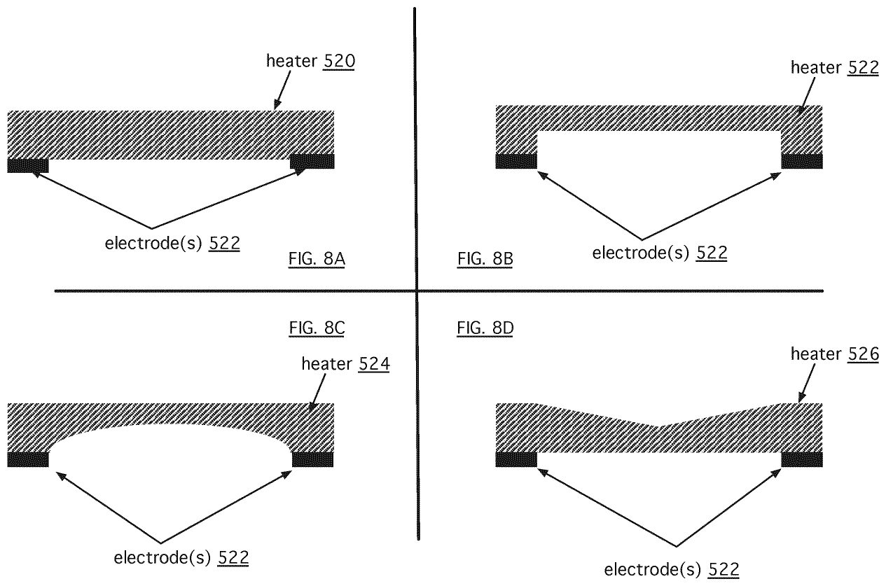

FIGS. 8A-8D illustrate example heater element profiles. In the example of FIG. 8A, heater 520 is configured with a substantially uniform thickness across the heater element boundaries. In the example of FIGS. 8B-8D , the heater material is configured to be thicker at its periphery. In an example of operation, a heater element comprising heater 520 is configured with thicker periphery material at the electrodes 522 In a related example, heater element profiles can be adapted to achieve a regular ohmic effect, controllably increasing resistance closer to the center of a given unit cell. In another related example, the heater element shape can be adapted to achieve a non-linear effect of electron mean-free path, which can also increase resistance at the center of the unit cell. Accordingly, a heater element configured to be thinner closer to the center of the unit cell can provide relatively higher resistance at the center of the heater, while also providing heat dissipation and reducing thermal crosstalk between adjacent unit cells. In yet another example, the heater shape can be adapted to provide substantially optimized current requirements for a unit cell array during operation. In an example of implementation, various combinations of heater/heater element shapes and configurations, such as those illustrated in FIGS. 6A-8D can be used to manage and influence heat maps for heater elements in light modulation unit cell arrays.

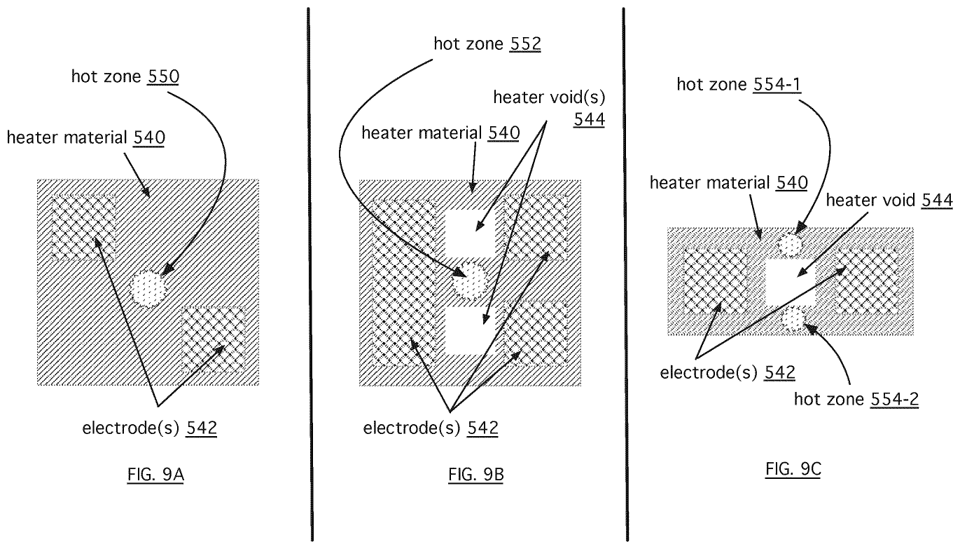

FIGS. 9A-9C illustrate various heater element and electrode configurations for a light modulation unit cell. FIG. 9A illustrates a cell heater element comprising electrodes 542 spaced diagonally on a square heater material 540. In an example, when current flows between electrodes 542, a hot zone 550 results in the relative center point between the electrodes. In an example, the cell layout of FIG. 9A can result in nonuniform current density across the heater element, with cold areas requiring additional energy to meet a required temperature threshold. FIG. 9B illustrates another cell layout for a unit cell, configured with heater void(s) 544 in the heater material 540. In an example one or more heater void(s) 544, can be provided between electrodes 542 in heater material 540. In various examples, the heater void(s) 544 can facilitate power reduction due to higher heater resistance from a same current flow. In an example of implementation, conductivity gaps in the heater element are formed with a normal heater/resistor mask and etched to create heater void(s) 544. FIG. 9C illustrates yet another cell layout for a unit cell, configured with a single heater void 544 in the heater material 540 to improve current uniformity. In the example of FIG. 9C, the heater material 540 takes a rectangular shape (as opposed to square), providing for two hot zones: hot zone 554-1 and hot zone 554-2.

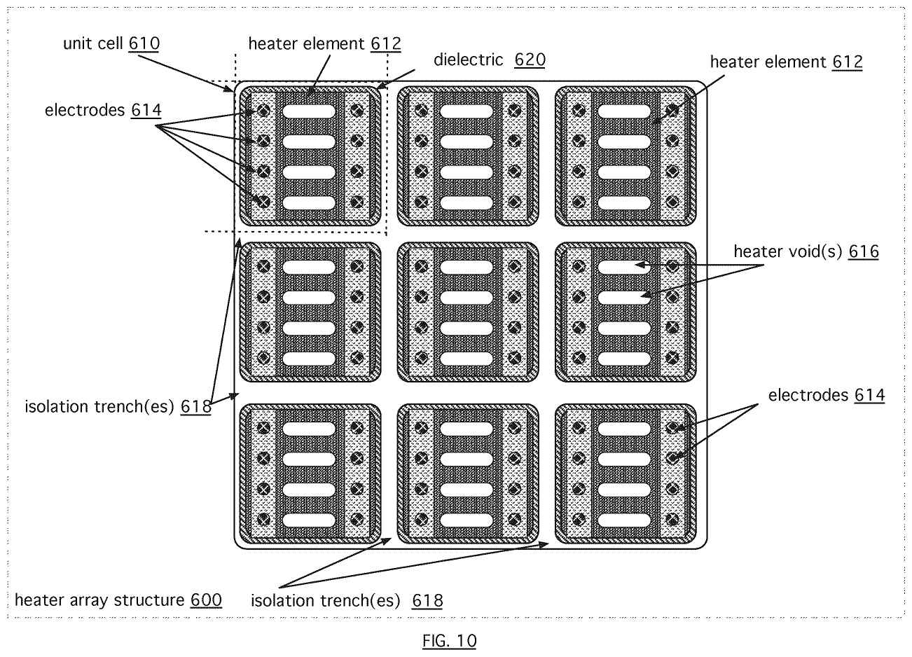

FIG. 10 illustrates an example heater array structure 600, comprising a 9×9 array of heater elements 612 for a 9×9 array of light modulation unit cells. In the example, each unit cell 610 of the array is associated with a heater element 612 that includes 8 electrodes 614, configured to enable current to flow from 4 electrodes 614 on one side of heater element 612 through heater element 612 to 4 electrodes 614 on a second side of heater element 612. In the various examples included herein, interconnects are formed to provide electrical connections between various elements of a CMOS FEOL and elements of a each unit cell of a unit cell array. Accordingly, electrodes 614 can be defined as interconnects adapted for providing electrical connections to heater element 612.

In an example, heater void(s) 616 are disposed between the first and second sides of heater element 612 to control the heat map pattern for each heater element 612. In an example, isolation trench(es) 618 can be used to mitigate thermal cross talk between adjacent unit cells 610. In another example, isolation trench(es) 618 can be used to enable substantially optimized current requirements for heater array structure 600 and the associated unit cells. In yet another example, heater element 612 can be formed on dielectric 620 that is adapted to leave an insulating region around heater element 620 to provide electrical and/or thermal isolation from adjacent heater elements.

It is noted, that although the description above mainly refers to devices for displaying and/or projecting images, the light modulation elements described herein can be used in a broad ranges of applications such as, for example, memory devices, optical routers, optical tweezers, neutral atom computing devices, cell trapping devices, microscopy devices, imaging devices, light sheet devices, printing devices, 3D projection devices, 3D displays, 2D projection devices, 2D displays, heads-up displays (HUDs), virtual reality devices, wavefront shaping devices, augmented reality devices and volumetric displays.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

1-44. (canceled)

45. A light modulation array, comprising:
a substrate;
a plurality of light modulation elements over the substrate; and
an isolation structure between two adjacent light modulation elements of the plurality of light modulation elements,
wherein:
an individual light modulation element of the plurality of light modulation elements includes a stack, the stack comprising:
a heater element over the substrate,
a first dielectric material over the heater element,
a mirror layer over the first dielectric material,
a second dielectric material over the mirror layer, and
a phase change material over the second dielectric material, wherein the phase change material is to change a phase based on a thermal contribution from the heater element,
the individual light modulation element of the plurality of light modulation elements further includes a third dielectric material,
the third dielectric material encapsulates the stack at least over a sidewall and a top surface of the stack,
a thermal conductivity of the third dielectric material is lower than a thermal conductivity of the first dielectric material and a thermal conductivity of the second dielectric material, and
the individual light modulation element of the plurality of light modulation elements further includes a first electrically conductive interconnect and a second electrically conductive interconnect connected to a bottom surface of the heater element.

46. The light modulation array of claim 45, wherein the first dielectric material is in physical contact with:
a top surface of the heater element.

47. The light modulation array of claim 46, wherein:
a bottom surface of the mirror layer is in physical contact with the first dielectric material, and
a top surface of the mirror layer is in physical contact with the second dielectric material.

48. The light modulation array of claim 47, wherein:
a sidewall of the mirror layer is in physical contact with a portion of the third dielectric material that encapsulates the stack on the sidewall of the stack or with a portion of the first dielectric material or with a portion of the second dielectric material.

49. The light modulation array of claim 48, wherein:
a bottom surface of the phase change material is in physical contact with the second dielectric material.

50. The light modulation array of claim 45, wherein a pitch of the two adjacent light modulation elements of the plurality of light modulation elements is smaller than a wavelength of light to be modulated by the light modulation array.

51. The light modulation array of claim 45, wherein the isolation structure is a void comprising vacuum or a void comprising a gaseous material.

52. The light modulation array of claim 45, wherein the isolation structure is an opening comprising a solid dielectric material.

53. The light modulation array of claim 45, wherein the heater element has one or more voids.

54. The light modulation array of claim 45, wherein the heater element has an increasing resistance closer to a center of the heater element.

55. The light modulation array of claim 45, wherein the heater element has a serpentine shape having a first end and a second end, wherein the first electrically conductive interconnect is coupled to the first end and the second electrically conductive interconnect is coupled to the second end.

56. A light modulation array, comprising:
a substrate;
a plurality of light modulation elements over the substrate; and
an isolation structure between two adjacent light modulation elements of the plurality of light modulation elements,
wherein:
an individual light modulation element of the plurality of light modulation elements includes a mirror over the substrate and a stack over the mirror, the stack comprising:
a heater element, and
a phase change material over the heater element, wherein the phase change material is to change a phase based on a thermal contribution from the heater element,
the individual light modulation element of the plurality of light modulation elements further includes:
a first dielectric material encapsulating the mirror, and
a second dielectric material separating the heater element from the phase change material.

57. The light modulation array of claim 56, wherein the heater element is transparent or semitransparent to wavelengths of light to be modulated by the light modulation array.

58. The light modulation array of claim 56, further comprising:
a passivation layer,
wherein the passivation layer is a materially continuous layer extending over the plurality of light modulation elements and the isolation structure.

59. The light modulation array of claim 56, wherein a pitch of the two adjacent light modulation elements of the plurality of light modulation elements is smaller than a wavelength of light to be modulated by the light modulation array.

60. A light modulation array, comprising:
a substrate;
a plurality of light modulation elements over the substrate, wherein an individual light modulation element of the plurality of light modulation elements includes a stack, the stack comprising:
a heater element above the substrate,
a first dielectric material above the heater element,
a reflective layer above the first dielectric material,
a second dielectric material above the reflective layer, and
a phase change material over the second dielectric material, wherein the phase change material is to change a phase based on a thermal contribution from the heater element, and wherein:
the individual light modulation element of the plurality of light modulation elements further includes a third dielectric material,
the third dielectric material encapsulates the stack, and
a thermal conductivity of the third dielectric material is lower than a thermal conductivity of the first dielectric material and a thermal conductivity of the second dielectric material.

61. The light modulation array of claim 60, wherein the heater element has one or more voids.

62. The light modulation array of claim 60, wherein the heater element has an increasing resistance closer to a center of the heater element.

63. The light modulation array of claim 60, wherein the reflective layer includes a plurality of sub-layers, wherein the plurality of sub-layers includes a first sub-layer comprising a first material having a refractive index R and a second sub-layer comprising a second material having a refractive index S, wherein R is greater than S.

64. The light modulation array of claim 60, wherein the reflective layer has a top surface and a bottom surface, and wherein the reflective layer has a continuously variable refractive index between the top surface and the bottom surface.
